(19) United States
(12) Patent Application Publication
(10) Pub. No.: US 2012/0102466 A1
(43) Pub. Date: Apr. 26, 2012

(54) Collaborative Software Debugging In A Distributed System With Graphic Representation Of Source Code Ownership Assignments

(75) Inventor: CARY L. BATES, ROCHESTER, MN (US)

(73) Assignee: INTERNATIONAL BUSINESS MACHINES CORPORATION, ARMONK, NY (US)

(21) Appl. No.: 12/908,990

(22) Filed: Oct. 21, 2010

(51) Int. Cl. G06F 9/44; G06F 3/00

(52) U.S. Cl. 717/125; 717/124

(57) ABSTRACT

In a distributed system that includes a debug server and debug clients coupled for data communications through a data communications network, where the debug server includes a debug administrator, a message router, a back-end debugger, and a debuggee, collaborative software debugging includes receiving application-level messages including receiving a request to assign ownership of a portion of source code; routing the application-level messages among the debug clients, the debug administrator, and the back-end debugger, including providing distributed control of the back-end debugger and forwarding, to the debug administrator, the request to assign ownership of the portion of source code; assigning ownership of the portion of the source code to the owning debug client; and returning, to the debug clients, client-specific debug results, including returning to the debug clients a description of the assignment of ownership to the owning debug client.

### BACKGROUND OF THE INVENTION

1. Field of the Invention

The field of the invention is data processing, or, more specifically, methods, apparatus, and products for collaborative software debugging in a distributed system.

2. Description of Related Art

Software source code is increasingly complex and is often developed by various developers, sometimes physically dispersed from one another. One part of software development, source code debugging, is especially complex in today's distributed software development environments. In debugging, it is often useful for two or more developers to work together in real-time to debug the source code. Further, during such debugging, developers may have differing interests in different portions of the source code. At present, there are no debug engines available that enable remotely distributed developers to debug the same source code collaboratively in real-time, while separately viewing different results of the same debugging.

### SUMMARY OF THE INVENTION

Methods, apparatus, and products for collaborative software debugging in a distributed system are disclosed. In embodiments of the present invention, the distributed system includes a debug server, a plurality of debug clients, and a data communications network. The debug server is coupled for data communications to the plurality of debug clients through the data communications network and the debug server includes a debug administrator, a message router, a back-end debugger, and a debuggee. From the perspective of the debug server, collaborative software debugging in the distributed system includes: receiving, by the debug server from the debug clients asynchronously during a debug session of the debuggee, a plurality of application-level messages including receiving a request to assign ownership of a portion of the debuggee's source code to an owning debug client; routing, by the message router in accordance with an application-level message passing protocol, the application-level messages among the debug clients, the debug administrator, and the back-end debugger, including providing distributed control of the back-end debugger to the debug clients with application-level messages routed to the back-end debugger and forwarding, to the debug administrator, the request to assign ownership of the portion of the debuggee's source code; assigning, by the debug administrator to the owning debug client, ownership of the portion of the debuggee's source code; and returning, by the debug server to the debug clients in response to the application-level messages routed to the back-end debugger, client-specific debug results, including returning to the debug clients a description of the assignment of ownership to the owning debug client.

From the perspective of the debug clients, collaborative software debugging in accordance with embodiments of the present invention includes presenting, by each debug client to a user of the debug client, a client-specific graphical user interface (‘GUI’), the client-specific GUI comprising a client-specific display of a debug session of the debuggee; detecting, by each debug client, user input through the client-specific GUI, including detecting user input indicating a request to assign ownership of a portion of the debuggee's source code to an owning debug client; generating, by each debug client in dependence upon the detected user input, one or more application-level messages, including generating the request to assign ownership; sending, by each debug client, the application-level messages to the debug server, including sending, to the debug server, the request to assign ownership; receiving, by each debug client responsive to the application-level messages, client-specific debug results, including receiving a description of the assignment of ownership to the owning debug client; and displaying, by each debug client in the client-specific GUI, the client-specific debug results, including displaying the portion of the debuggee's source code for which ownership is assigned to the owning debug client differently than other portions of the debuggee's source code for which ownership is not assigned to the owning debug client.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram of a distributed system in which collaborative software debugging is carried out according to embodiments of the present invention.

FIG. 2 sets forth an example client-specific graphical user interface (‘GUI’) presented to a user of a debug client in accordance with embodiments of the present invention.

FIG. 3 sets forth a flowchart illustrating an exemplary method of collaborative software debugging in a distributed system in accordance with embodiments of the present invention.

FIG. 4 sets forth a sequence diagram illustrating a further exemplary method of collaborative software debugging in accordance with embodiments of the present invention in which a debug client requests to join a debug session.

FIG. 5 sets forth a sequence diagram illustrating a further exemplary method of collaborative software debugging in accordance with embodiments of the present invention in which a debug client requests to leave a debug session.

FIG. 6 sets forth a sequence diagram illustrating a further exemplary method of collaborative software debugging in accordance with embodiments of the present invention in which a debug client requests to distribute data other debug clients.

FIG. 7 sets forth a sequence diagram illustrating a further exemplary method of collaborative software debugging in accordance with embodiments of the present invention in which a debug client requests to issue a command to the back-end debugger.

FIG. 8 sets forth a sequence diagram illustrating a further exemplary method of collaborative software debugging in accordance with embodiments of the present invention in which a debug client requests to establish an event notification with the back-end debugger.

FIG. 9 sets forth a sequence diagram illustrating a further exemplary method of collaborative software debugging in accordance with embodiments of the present invention in which a debug client requests to register a group of debug clients.

FIG. 10 sets forth a flowchart illustrating a further exemplary method of collaborative software debugging in a distributed system in accordance with embodiments of the present invention.

FIG. 11 sets forth a flowchart illustrating a further exemplary method of collaborative software debugging in a distributed system in accordance with embodiments of the present invention.

FIG. 12 sets forth a flowchart illustrating a further exemplary method of collaborative software debugging in a distributed system in accordance with embodiments of the present invention.

FIG. 13 sets forth a flowchart illustrating a further exemplary method of collaborative software debugging in a distributed system in accordance with embodiments of the present invention.

### DETAILED DESCRIPTION OF EXEMPLARY EMBODIMENTS

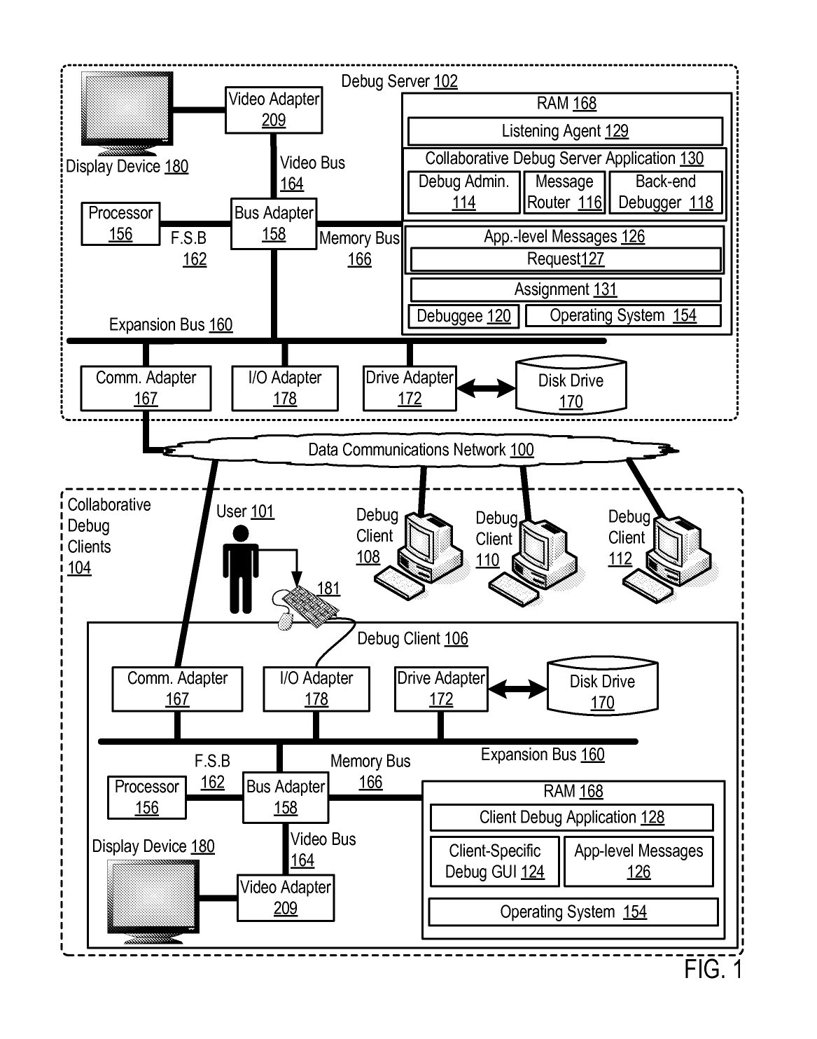

Exemplary methods, apparatus, and products for collaborative software debugging in a distributed system in accordance with the present invention are described with reference to the accompanying drawings, beginning with FIG. 1. FIG. 1 sets forth a network diagram of a distributed system in which collaborative software debugging is carried out according to embodiments of the present invention. The term ‘debug,’ and its variations—debugged, debugging, and so on—as used in this specification generally refers to a methodical process of finding and reducing the number of bugs, or defects, in a computer program, that is, in source code of the computer program. Debugging may also be carried out to produce other results—decrease source code size, increase efficiency of the source code, decrease memory use by the executed source code, and so on as will occur to readers of skill in the art. The source code of a software program or application being debugged is referred to in this specification as a ‘debuggee.’

The system of FIG. 1 is a distributed system. The term ‘distributed’ generally describes a system in which elements of the system are coupled for data communications through a data communications network, in many cases, a loosely-coupled data communications network. The distributed system of FIG. 1, for example, includes a debug server (102), a plurality of debug clients (104), and a data communications network (100). The debug server (102) in the example distributed system of FIG. 1 is coupled for data communications to the plurality of debug clients (104) through the data communications network (100). The term ‘distributed’ may also refer, as context requires, to the physical distribution of the debug clients (104). That is, each debug client (106, 108, 110, and 112) may physically remote from each of the other debug clients. Clients (106 and 108) may be located in different states in the United States, while client (110) may be located in China, and client (112) may be located in Japan. The plurality of clients (104) is ‘distributed’ physically in various locations.

In the distributed system of FIG. 1, each of the debug clients (106, 108, 110, and 112) and the debug server (102) is implemented as automated computing machinery, a computer. For clarity of explanation, not limitation, the components comprising the debug server (102) are similar to and bear the same numbers as corresponding components comprising each of the debug clients (104). Similar components may be described below with respect to only one of the debug server (102) or a debug client, but such descriptions applies to components of both the debug server and the debug client.

Each of the debug clients (106, 108, 110, 112) of FIG. 1 includes at least one computer processor (156) or ‘CPU’ as well as random access memory (168) (RAM') which is connected through a high speed memory bus (166) and bus adapter (158) to processor (156) and to other components of the debug clients (106, 108, 110, 112). The debug server (102) includes similar components coupled in similar ways.

Stored in RAM (168) of each debug client (106, 108, 110, 112) is a client debug application (128), a module of computer program instructions that, when executed by the computer processor (156) of the debug client, causes the debug client to carry out client-side collaborative software debugging in accordance with embodiments of the present invention. The client debug application (128) of each debug client, say client (106) as an example, carries out client-side collaborative software debugging in accordance with embodiments of the present invention by: presenting, by the debug client (106) to a user (not shown) of the debug client (106), a client-specific GUI (124). In the example of FIG. 1, the client-specific GUI (124) is a client-specific display of a debug session of the debuggee. The phrase ‘client-specific’ as used here describes a GUI and display of a debug session that may differ from other debug clients' GUI and display of the same debug session. A debug session is a semi-permanent interactive information interchange between at least one debug client and a debug server for the purposes of a debugging a particular debuggee. A session is set up or established at a certain point in time, and torn down at a later point in time. An established communication session may involve more than one message in each direction.

The client debug application (128) of the debug client (106) may also detect user input through the client-specific GUI, generate, in dependence upon the detected user (100) input, one or more application-level messages (126), and send the application-level messages to the debug server (102). The phrase ‘application-level’ is used to describe messages that have meaning at a particular level in a data communications protocol model or framework. Consider, as one example of a data communications protocol model, the Open Systems Interconnection model that has seven layers, the application layer being the ‘highest’ and the physical layer being the lowest. Consider also, as another example, the TCP/IP model, which sets forth the application layer at the highest level and a link layer at the lowest level. The relative terms—higher and lower—describe a protocol's ‘closeness’ with regard to physical hardware (cables and the like) upon which data communications are passed. Each higher layer is a greater level of abstraction. In both models, the application layer or application-level is the highest level, farthest away from hardware and most abstracted layer. In the examples provided here, the application-level messages are abstracted from the data communications protocols used to transmit the data making up the application-level messages across one or many physical connections.

Detecting user (100) input through the client-specific GUI (124) in the example of FIG. 1 may include detecting user input indicating a request (127) to assign ownership of a portion of the debuggee's source code to an owning debug client. In this specification a debug client is referred to as an ‘owning’ debug client when that debug client is to own a particular portion of the debuggee's source code. A debug client may ‘own’ a portion of source code for various reasons: the debug client originally generated the portion of source code, the debug client most recently edited the portion of source code, the debug client is expressly selected by a session owner to be an owner of the portion of source code, and so on as will occur to readers of skill in the art.

In the example of FIG. 1, generating application-level messages (126), in the example of FIG. 1 may include generating the request (127) to assign ownership. The request may implemented as an application-level message (126) having a DISTRIBUTE DATA message type or having a COMMAND REQUEST message type. Such application level-message are described in detail below. After generating the request (127), the debug client may send sending the request to assign ownership to the debug server.

The term ‘server’ may, as context requires, refer to either or both of a server application or a computer upon which such a server application is executing. For clarity, the debug server (102) in the example of FIG. 1 is depicted and described as a computer upon which a server application executes.

Stored in RAM (168) of the debug server (102) is a listening agent (129), a module of computer program instructions that listens on a port for debug client requests where that port is well-known to the client. The listening agent (129) may also provide debug clients with a list of available collaborative debug server applications (130) or begin execution of a particular collaborative debug server application (130) upon request. A debug client, for example, may request that a particular type of collaborative debug server application be started for debugging a particular debuggee. The server (102) in the example of FIG. 1, may support simultaneous execution of several different debug server applications, each of which may debug separate debuggees. The listening agent may also provide to a requesting debug client, a port, socket, or other data communications identifier of the collaborative debug server application with which the requesting debug client is to communicate with during a debug session. That is, the listening agent (129) effectively brokers communications between a collaborative debug server application (130) and a debug client (104).

Also stored in RAM (168) of the debug server (102) is a collaborative debug server application (130), a module of computer program instructions that, when executed by the computer processor (156) of the debug server, causes the debug server (102) to carry out server-side collaborative software debugging in accordance with embodiments of the present invention. The collaborative debug server application (130) also includes a debug administrator (114), a message router (116), a back-end debugger (118), and a debuggee (120).

The debug administrator (114) is a module of computer program instructions that administers a collaborative debug session, administering client identifiers, registering and unregistering clients in a debug session, and so on. A back-end debugger (118) is an application that controls operation of another application—the debuggee (120)—for the purpose of testing execution of the debuggee. The source code of the debuggee may run on an instruction set simulator (ISS), a technique that allows great power in its ability to halt when specific conditions are encountered but which will typically be somewhat slower than executing the code directly on a processor for which the code is written. When execution of a program crashes or reaches a preset condition, a debugger typically displays the position in the source code at which the execution of the program crashed. A ‘crash’ occurs when the program cannot normally continue because of a programming bug. In addition to displaying a position in source code when execution of the source code crashes, debuggers also often offer other functions such as running a program step by step (single-stepping or program animation), stopping, breaking, or pausing the program to examine the current state, at some event or specified instruction by means of a breakpoint, and tracking the values of some variables.

The term ‘back-end’ is used here to indicate that the debugger (118) in the example of FIG. 1 is indirectly controlled by multiple clients. As explained below in detail, the back-end debugger (118) is controlled indirectly by multiple clients through use of an intermediary—the message router (116). From the perspective of the back-end debugger (118), the debugger is controlled by a single source, the message router (116). The message router, however, operates as intermediary between multiple debug clients and the debugger. The term ‘back-end’ may be further described by contrast to the term ‘front-end.’ Debugger front-ends are popular extensions to debugger engines that provide Integrated Development Environment (IDE') integration, program animation, and visualization features, rather than console-based command line interfaces. The ‘front-end’ directly faces a client, in contrast to the ‘back-end’ debugger (118) in the example of FIG. 1, which interfaces indirectly with the clients through the message router (116).

The collaborative debug server application (130) carries out server-side collaborative software debugging in accordance with embodiments of the present invention by: receiving, by the debug server (102) from the debug clients (104) asynchronously during a debug session of the debuggee (120), a plurality of application-level messages (126); routing, by the message router (116) in accordance with an application-level message passing protocol, the application-level messages (126) among the debug clients, the debug administrator, and the back-end debugger. In routing the messages in the example of FIG. 1, the message router (116) provides distributed control of the back-end debugger (118) to the debug clients (104) with the application-level messages (126) routed to the back-end debugger (118). The debug server application (138) also returns, to the debug clients (104) in response to the application-level messages routed to the back-end debugger, client-specific debug results.

In embodiments such as those described above in which a debug client detects user input indicating a variable in source code of the debuggee, generates, and sends a request to assign ownership to the debug server, the debug server (102) may receive the request (127) and forwarding the request (127) to the debug administrator (114) to assign ownership of the portion of the debuggee's source code. The debug administrator (114) may then assign, to the owning debug client, ownership of the portion of the debuggee's source code. The debug administrator (114) may return information describing the assignment to the message router, which in turn sends to the debug clients (104) a description of the assignment of ownership to the owning debug client. In this way, each debug client is notified of ownership assignments of portions of source code.

Each debug client (106, 108, 110, 112), is also configured to receive the client-specific debug results as application-level reply messages (126) and display, in the client-specific GUI (180), the client-specific debug results. In the example of FIG. 1, each the debug client also receives the description of the assignment (131) of ownership and displays, on the client-specific debug GUI (124) the portion of the debuggee's source code for which ownership is assigned to the owning debug client differently than other portions of the debuggee's source code for which ownership is not assigned to the owning debug client. For example, a debug client may display text of the owning debug client's portion of source code in a red color while display text of other portions in a black color. Alternatively, or in addition to color variations, a debug client may display the owning debug client's portion of source code in association with another type of graphic representation of ownership—a pictograph, an avatar identifying the owning debug client, an icon identifying an owning debug client, or some other graphic representation of ownership. Readers of skill in the art will recognize that these are but a few among many possible implementations of a graphic representation of ownership.

Also stored RAM (168) of the debug server (102) and debug clients (104) is an operating system (154). An operating system is a computer software component that is responsible for execution of application programs and for administration of access to computer resources, memory, processor time, and I/O functions, on behalf of application programs. Operating systems useful in computers of a distributed system in which collaborative software debugging is carried out according to embodiments of the present invention include UNIX™, Linux™, Microsoft XP™, AIX™, IBM's i5/OS™, and others as will occur to those of skill in the art. The operating system (154), collaborative debug server application (130), debuggee (120), client debug application (128), client-specific debug GUI (124), and so on in the example of FIG. 1 are shown in RAM (168), but many components of such software typically are stored in non-volatile memory also, such as, for example, on a disk drive (170).

Each of the debug server (102) and debug clients (104) of FIG. 1 includes disk drive adapter (172) coupled through expansion bus (160) and bus adapter (158) to processor (156) and other components of the debug server (102) and debug clients (104). Disk drive adapter (172) connects non-volatile data storage to each of the debug server (102) and debug clients (104) in the form of disk drive (170). Disk drive adapters useful in computers that provide collaborative software debugging according to embodiments of the present invention include Integrated Drive Electronics ('IDE') adapters, Small Computer System Interface (SCSI') adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

Each of the example debug server (102) and debug clients (104) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. Each of the example debug server (102) and debug clients (104) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

Each of the example debug server (102) and debug clients (104) of FIG. 1 includes a communications adapter (167) for data communications with other computers and for data communications with a data communications network (100). Such data communications may be carried out serially through RS-232 connections, through external buses such as a Universal Serial Bus ('USB'), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers that provide collaborative software debugging according to embodiments of the present invention include modems for wired dial-up communications, Ethernet (IEEE 802.3) adapters for wired data communications network communications, and 802.11 adapters for wireless data communications network communications.

The arrangement of debug servers, debug clients, data communications networks, and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

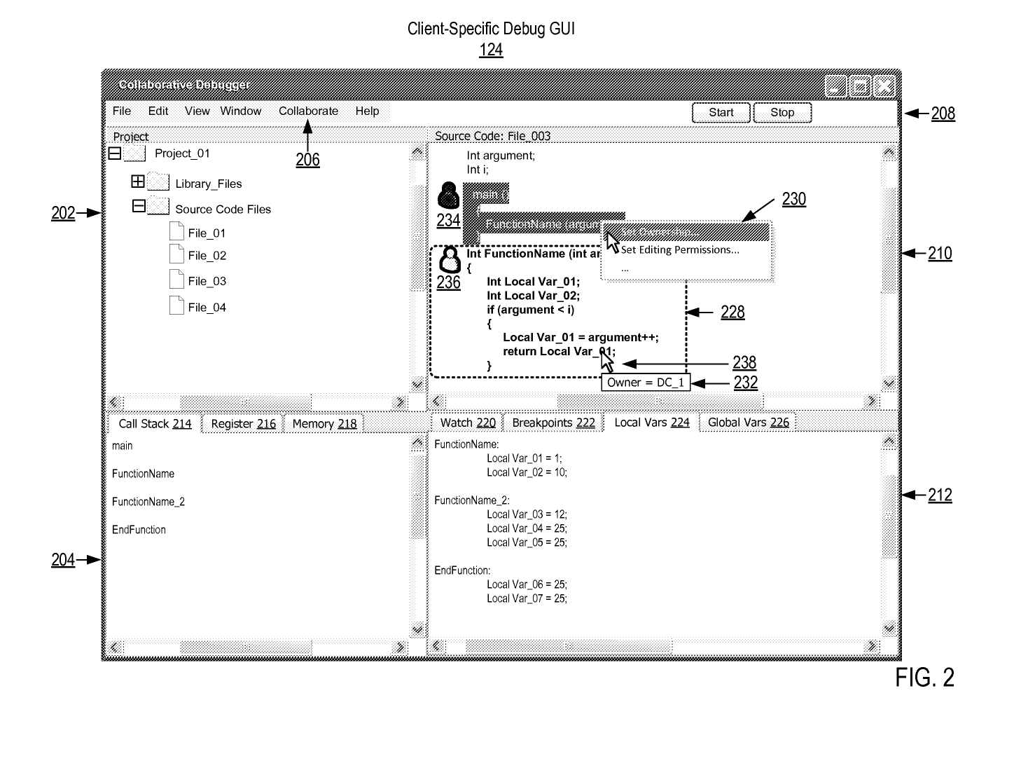

For further explanation, FIG. 2 sets forth an example client-specific GUI presented to a user of a debug client in accordance with embodiments of the present invention. The example GUI (124) of FIG. 2 provides an interface for a user of a debug client to effectively control, collaboratively with other client debuggers, the back-end debugger of a debug server.

The debug GUI of each debug client in a distributed system for which collaborative software debugging is carried out in accordance with embodiments of the present invention is client-specific, meaning any one debug GUI may be configured differently, displayed differently, or operate differently, than any other debug client's GUI, while all debug clients collaboratively control the same, single back-end debugger of a debug server during the same debug session of the same debuggee. One debug GUI may display the source code at one location (line number) while another debug GUI displays the source code at another location; one debug GUI displays a call stack of one thread, while another debug GUI displays a call stack of another thread; one debug GUI displays evaluation results of one variable, while another debug GUI displays evaluation results of another variable; and so on as will occur to readers of skill in the art. The example client-specific debug GUI (124) of FIG. 2 provides a client-specific display of debugging along with collaborative, or ‘distributed,’ control of the debugger, rather than all debug clients displaying only the same GUI as a single master debug client, where the master client has absolute, not collaborative, control over the debugger until passing that control to another client.

The example GUI (124) of FIG. 2 includes a menu bar (208), including a number of separate menus: a File menu, an Edit menu, a View menu, a Collaborate menu, and a Help menu. The Collaborate menu (206), when selected, may provide a user with various menu items that support collaborative debugging.

The example GUI (124) of FIG. 2 also includes several independent portions—called panes (as in ‘window panes’) for clarity of explanation—a project pane (202), a source code pane (210), and two separate data panes (204, 212). Project pane (202) presents the files and resources available in a particular software development project. Source code pane (210) presents the source code of debuggee. The data panes (204, 212) present various data useful in debugging the source code. In the example of FIG. 2, data pane (204) includes three tabs, each of which presents different data: a call stack tab (214), a register tab (214), and a memory tab (218). Data pane (212) includes four tabs: a watch list tab (220), a breakpoints (222) tab, a local variable tab (224), and a global variable tab (226).

The GUI (124) in the example of FIG. 2 displays ownership of portions of source code of a debuggee in accordance with embodiments of the present invention in various ways. The portion (228) of source code relating to the function called “FunctionName” is displayed in a different color than other portions of text—the text in FIG. 2 of this portion (228) is bold unlike other portions. In addition to differing text color, a pictograph (236) is associated with the portion (228) of source code. A pictograph is (also called pictogram) is an ideogram that conveys meaning through its pictorial resemblance to a physical object. In this example, the pictograph (236) is implemented as an icon or avatar of a user that ‘owns’ the portion (228) of source code. The icon is not filled and is distinct from other icons associated with other users or debug clients, such as the icon (234) displayed in association with the portion of source code relating to the function call ‘main.’

The example GUI of FIG. 2 also displays ownership information upon a mouse-over, or hover-over, of a portion of source code. In the example of FIG. 2, a user has directed a pointer (238)—through a user input device such as a mouse—over the portion (228) of source code for which ownership is assigned. On a hover-over, debug client displays, in the client-specific GUI (124) of FIG. 2, ownership information, namely that the portion (228) of source code is owned by DC_1.

Also in the example GUI (124) of FIG. 2, a user may, through selection of a text in the source code and an invocation of an alternative-mouse-click (right-click), request a change in ownership of the portion of source code. In the example GUI (124) of FIG. 2, a user has selected the portion of source code related to the ‘main’ function and, through an alternative-click, invoked the GUI (124) to display the pop-up selection menu (230). The user selects the menu-item to “set ownership.” Upon selection of the menu item, the GUI receives a request to assign ownership, generates the request as one or more application-level message, and sends the request to the debug server.

The GUI items, menus, window panes, tabs, and so on depicted in the example client-specific GUI (124) of FIG. 2, are for explanation, not for limitation. Other GUI items, menu bar menus, drop-down menus, list-boxes, window panes, tabs, and so on as will occur to readers of skill in the art may be included in client-specific GUIs presented by debug clients in a distributed system in which collaborative software debugging is carried out in accordance with embodiments of the present invention.

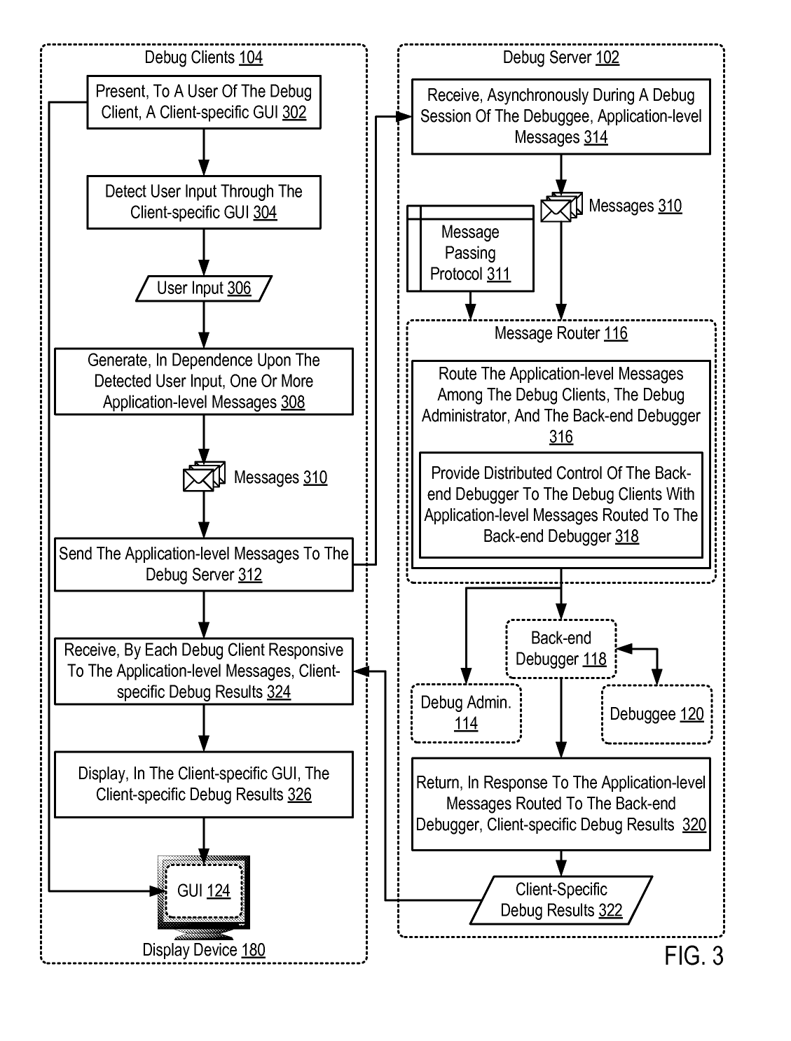

For further explanation, FIG. 3 sets forth a flowchart illustrating an exemplary method of collaborative software debugging in a distributed system in accordance with embodiments of the present invention. In the method of FIG. 3, the distributed system includes a debug server (102), a plurality of debug clients (104), and a data communications network (100 on FIG. 1). The debug server (102) is coupled for data communications to the plurality of debug clients (104) through the data communications network (100). The debug server (102) further includes a debug administrator (114), a message router (116), a back-end debugger (118), and a debuggee (120).

The method of FIG. 3 includes presenting (302), by each debug client (104) to a user (101 on FIG. 1) of the debug client (104), a client-specific GUI (124). In the method of FIG. 3, each debug client's (104) client-specific GUI (124) is implemented as a client-specific display of a debug session of the debuggee (120). Presenting (302) a client-specific GUI (124) may be carried out by rendering the GUI (124) on a display device (180), with each debug client operating semi-independently from other debug clients in presenting the GUI (124). As mentioned above, each GUI (124) may be display different debugging attributes even though each of the debug clients presenting the GUI (124) are participating in the same debug session of the same debuggee.

The method of FIG. 3 also includes detecting (304), by each debug client (104), user (101 on FIG. 1) input (306) through the client-specific GUI (124). Detecting (304), user input (306) through the client-specific GUI (124) may be carried out in various ways including, for example, detecting mouse-overs, detecting keyboard keystrokes, detecting keyboard shortcuts, detecting explicit commands entered into a field presented to receive such commands, detecting selection of drop-down menu items, detecting mouse-clicks on GUI items, such as GUI buttons, and so on.

The method of FIG. 3 also includes generating (308), by each debug client (104) in dependence upon the detected user input (306), one or more application-level messages (310) and sending (312), by each debug client (104), the application-level messages (310) to the debug server (102). Generating (308) one or more application-level messages (310) may be carried out by identifying, from message generation rules, a message type, and creating application-level messages of the message type that includes at least an identification of a sender, a recipient, and the message type. Examples of message types are described below in detail and include a JOIN message type, a LEAVE message type, a DISTRIBUTE REQUEST message type, a COMMAND REQUEST message type, and EVENT REQUEST message type, a REGISTER GROUP message type, a CONFIRMATION REPLY message type, a REQUEST REPLY message type, and an EVENT REPLY message type.

The method of FIG. 3 also includes receiving (314), by the debug server (102) from the debug clients (104) asynchronously during a debug session of the debuggee (120), the application-level messages (310). Receiving (314) the application-level messages (310) may be carried out by listening on a well-known data communications socket, upon which application-level messages (310) of the kind sent by the debug clients (104) are expected to be received.

The method of FIG. 3 also includes routing (316), by the message router (116) in accordance with an application-level message passing protocol (311), the application-level messages (310) among the debug clients (104), the debug administrator (114), and the back-end debugger (118). In the method of FIG. 3, routing (316) the application-level messages (310) includes providing (318) distributed control of the back-end debugger (118) to the debug clients (104) with application-level messages (310) routed to the back-end debugger (118). That is, the messages routed to the back-end debugger—message received from any of the debug clients at any time during the debug session of the debuggee—control operation of the back-end debugger. The application-level messages control debugging of the debugging.

The method of FIG. 3 also includes returning (320), by the debug server (102) to the debug clients (104) in response to the application-level messages (310) routed to the back-end debugger (118), client-specific debug results (322). Returning (320), client-specific debug results (322) to the debug clients (104) may be carried out by generating, by the debug server or more specifically, the message router (116), one or more application-level messages forming a reply or replies that include the results and sending the replies to the debug clients via the data communications network (100 on FIG. 1).

The method of FIG. 3 also includes receiving (324), by each debug client (104) responsive to the application-level messages (310), client-specific debug results (322) and displaying (326), by each debug client in the client-specific GUI (124) on a display device (180), the client-specific debug results (322).

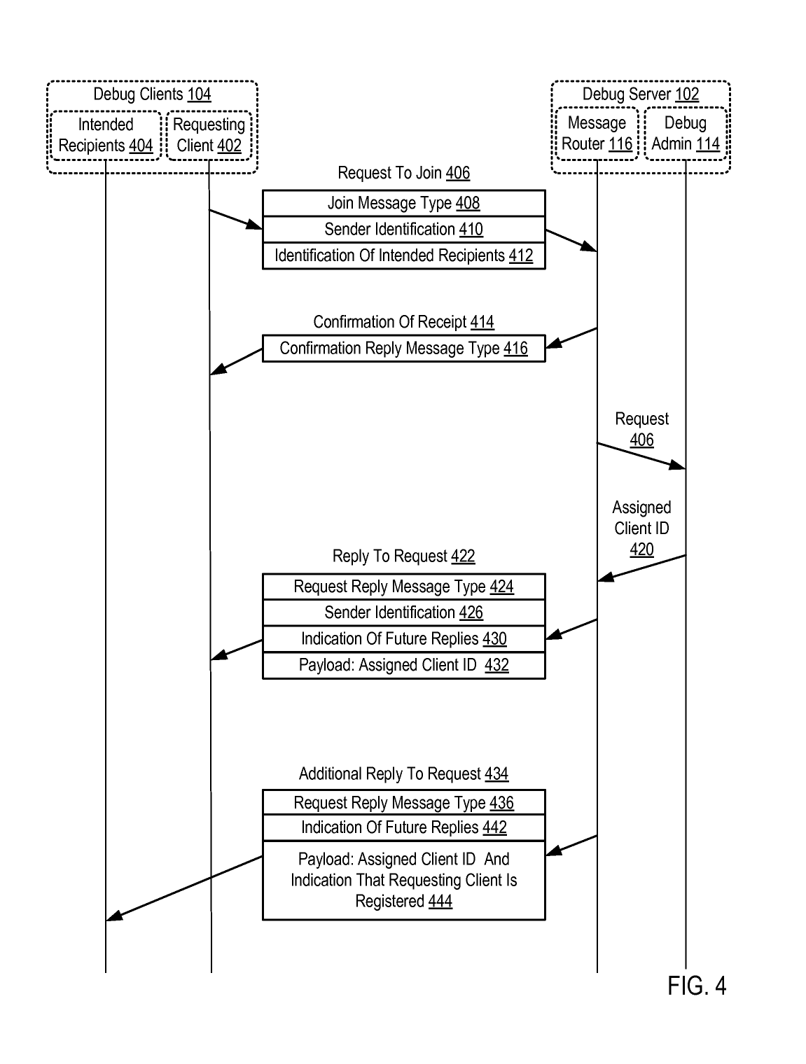

As described above, once received by a debug server (102) from a debug client, an application-level message (310) in the example of FIG. 3, the application-level message (310) is routed to one of a back-end debugger (118), a debug administrator (114), or one or more other debug clients (104) in dependence upon an application-level message passing protocol (311). For further explanation of such a message passing protocol useful in distributed systems in which collaborative software debugging is carried out in accordance with embodiments of the present invention, FIGS. 4-9 set forth various sequence diagrams that illustrate message passing in accordance with the message passing protocol. FIG. 4, therefore, sets forth a sequence diagram illustrating a further exemplary method of collaborative software debugging in accordance with embodiments of the present invention in which a debug client requests to join a debug session. The method of FIG. 4 is carried out in a distributed system similar to the system of FIG. 1 which includes a debug server (102), a plurality of debug clients (104), and a data communications network (100 on FIG. 1). The debug server (102) is coupled for data communications to the plurality of debug clients (104) through the data communications network (100). The debug server (102) further includes a debug administrator (114), a message router (116), a back-end debugger (118 on FIG. 1), and a debuggee (120 on FIG. 1).

The method of FIG. 4, illustrated in a sequence diagram rather than a flowchart, is similar to the method of FIG. 3 in that the method of FIG. 4 depicts a debug client—the requesting client (402) of FIG. 4—generating (308 on FIG. 3) one or more application-level messages (310 on FIG. 3). In the example of FIG. 4, the requesting client (402) generates a request (406) to join the debug session. In the method of FIG. 4, the request is implemented as an application-level message having a JOIN REQUEST message type (408), an identification (410) of the sender of the request to join (such as an IP address, Socket Number, or port number), and an identification (412) of one or more intended recipients. Such intended recipients may include the sender, all other debug clients registered in the session, or some subset of debug clients registered in the session. As explained below in more detail, an identification of an intended recipient in the example request (406) to join is not an identification of a recipient of the request itself—the debug server (102) is the recipient of the request itself—instead, the identification of an intended recipient in the request join actually identifies a recipient of future replies to the request. The request (406) may also include a message identifier, uniquely identifying the request. Responses to the request may include such a message identifier so that debug clients may identify the request to which the response relates.

In the example of FIG. 4, sending (312 on FIG. 3), by the requesting client (402), the application-level messages (310 on FIG. 3) to the debug server (102), includes sending the request (406) to join the debug session and receiving (314 on FIG. 3) the application-level messages (310 on FIG. 3) includes receiving, by the debug server (102) and, more specifically, the message router (116), the request (406) to join the debug session.

The method of FIG. 4 also includes sending, by the message router to the requesting debug client (402), in response to receiving the request (406), a confirmation (414) of receipt of the request (406) to join, the confirmation implemented as an application-level message having a CONFIRMATION REPLY message type (416). The confirmation may also include a message identifier that uniquely identifies the request (406) for which the confirmation reply is confirming receipt. The requesting debug client (402) in the example of FIG. 4 receives the confirmation (414). If the requesting debug client (402) does not receive a confirmation (414) after a predefined amount of time, the requesting client (402) may resend the request (406).

After receiving the request (406), the message router (116) routes (316 on FIG. 3) the application-level messages by forwarding the request (406) to join the debug session to the debug administrator (114). The debug administrator (114) then registers the requesting debug client (402) in the debug session and assigns the requesting debug client (402) a client identifier (420) unique to the debug session. After assignment a client identifier may be used in message passing among the debug clients, debug server, and debug administrator to identify a recipient of a message, to identify a sender of a message, and so on. The debug administrator (114) may maintain a list, or other data structure, of available client identifiers and a table, or other data structure, of assigned client identifier. A table of assigned client identifiers may include a plurality of entries, with each entry representing a single client. Each entry in such a table may associate a client identifier with another identification of the client—a MAC (Media Access Control) address, an IP (Internet Protocol) address, a socket identifier, and so on as will occur to readers of skill in the art.

After assigning the client identifier (420), the debug administrator (114) may return, to the message router (116), the assigned client identifier (420) and the message router (116) may send the client identifier (420) along to the requesting client (402) in a reply (422) to the request (406) to join the debug session. In the example of FIG. 4, the reply (422) is implemented as an application-level message having a REQUEST REPLY message type (424), an indication (430) of future replies responsive to the request (406) to join, an identification (426) of sender of the reply, and a payload (432) that includes the assigned client identifier (420). In the method of FIG. 4, the requesting client (402) receives the reply (422).

In the method of FIG. 4, the message router (116) also sends, to debug clients (404) identified as intended recipients in the request (406) to join, an additional reply (434) to the request (406) to join and the debug clients (404) receive the additional reply (434). In the method of FIG. 4, the additional reply (434) is implemented as an application-level message having a REQUEST REPLY message type (436), an indication (442) of future replies responsive to the request to join, and a payload (444) that includes the assigned client identifier (420) and an indication that the requesting debug client is registered in the debug session.

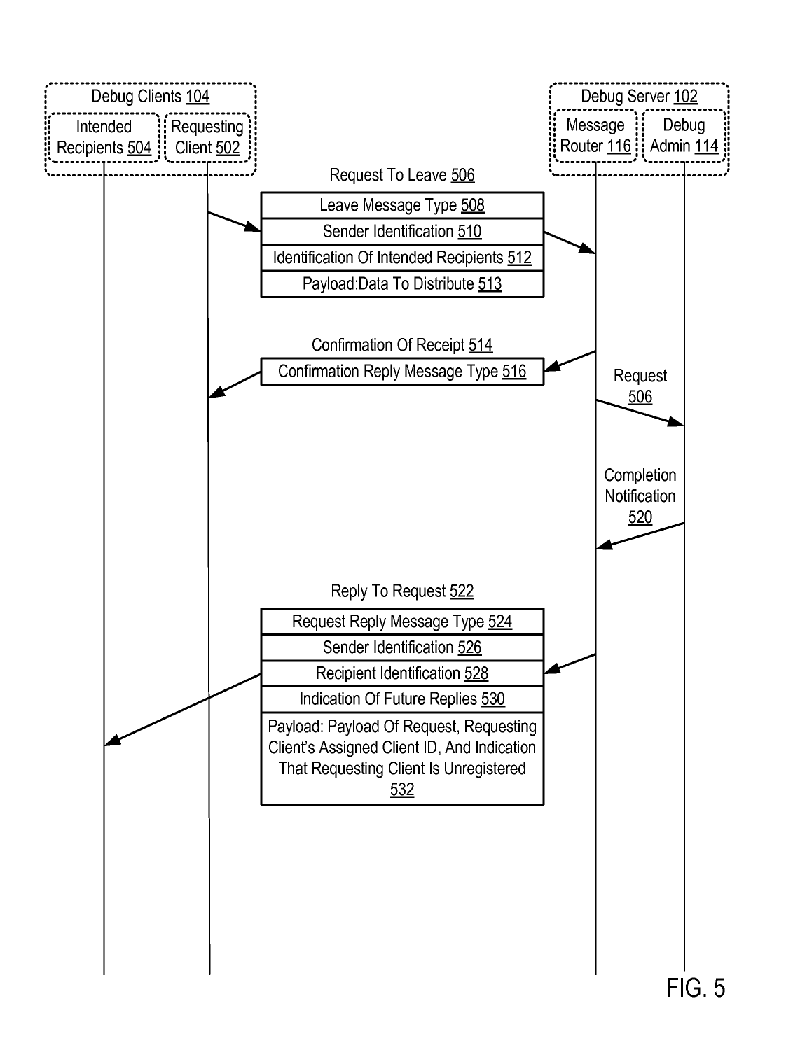

For further explanation, FIG. 5 sets forth a sequence diagram illustrating a further exemplary method of collaborative software debugging in accordance with embodiments of the present invention in which a debug client requests to leave a debug session. The method of FIG. 5 is carried out in a distributed system similar to the system of FIG. 1 which includes a debug server (102), a plurality of debug clients (104), and a data communications network (100 on FIG. 1). The debug server (102) is coupled for data communications to the plurality of debug clients (104) through the data communications network (100). The debug server (102) further includes a debug administrator (114), a message router (116), a back-end debugger (118 on FIG. 1), and a debuggee (120 on FIG. 1).

The method of FIG. 5 includes generating, by a requesting debug client (502), a request (506) to leave the debug session and receiving the request (502) to leave the debug session by the message router (116). In the example of FIG. 5, the request (506) is implemented as an application-level message having a LEAVE REQUEST message type (508), a sender's identification (510), an identification (512) of one or more intended recipients, and a payload (513) to distribute to the intended recipients upon leaving the debug session.

The method of FIG. 5 continues by the message router (116) sending, to the requesting debug client (502), a confirmation of receipt of the request (506) to leave and receiving by the requesting debug client (502) the confirmation. The confirmation in the example of FIG. 5 may be implemented as an application-level message having a CONFIRMATION REPLY message type (516).

The method of FIG. 5 also includes by forwarding the request (506) to leave the debug session to the debug administrator, unregistering, by the debug administrator (114), the requesting debug client from the debug session, including unassigning the requesting debug client's (502) client identifier, and returning, to the message router (116) a completion notification (520).

The message router (116) in the example of FIG. 5 then sends, to debug clients (504) identified as intended recipients in the request (502) to leave, a reply (522) to the request to leave and receiving, by the debug clients (504) identified as intended recipients, the reply (522) to the request to leave. The reply (522) may be implemented as an application-level message having a REQUEST REPLY message type (524), an identification (526) of a sender of the message, an identification of the recipient of the message (528), an indication (530) of future replies responsive to the request (506) to leave, and as a payload (542) of the reply, the payload (513) included in the request (513) to leave.

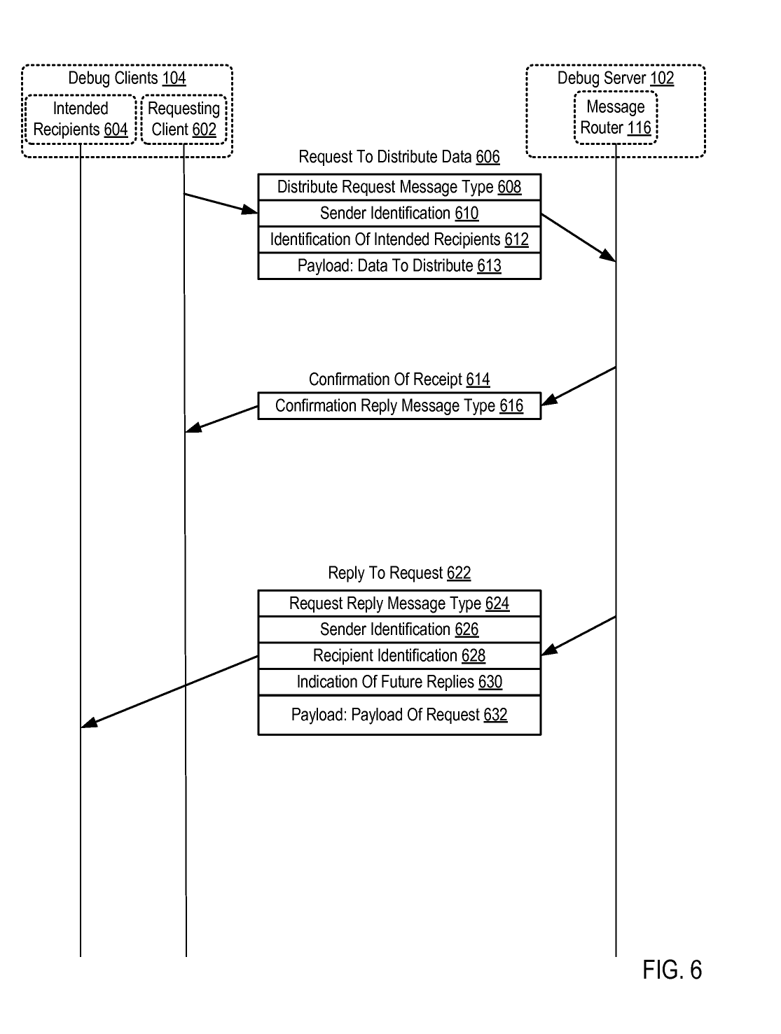

For further explanation, FIG. 6 sets forth a sequence diagram illustrating a further exemplary method of collaborative software debugging in accordance with embodiments of the present invention in which a debug client requests to distribute data other debug clients. The method of FIG. 6 is carried out in a distributed system similar to the system of FIG. 1 which includes a debug server (102), a plurality of debug clients (104), and a data communications network (100 on FIG. 1). The debug server (102) is coupled for data communications to the plurality of debug clients (104) through the data communications network (100). The debug server (102) further includes a debug administrator (114), a message router (116), a back-end debugger (118 on FIG. 1), and a debuggee (120 on FIG. 1).

The method of FIG. 6 includes generating, by a requesting debug client (602), a request (606) to distribute data (613) to debug clients registered in the debug session, sending, to the debug server, the request (606), and receiving, by the message router (116), the request (606). In the example of FIG. 6, the request (606) to distribute data may be implemented as an application-level message having a DISTRIBUTE REQUEST message type (608), an identification of a sender (610) of the message, an identification (612) of one or more intended recipients (604), and a payload that includes data (613) to distribute to the intended recipients.

Responsive to receiving the request (606), the message router (116) in the example of FIG. 6, sends, to the requesting debug client (602), a confirmation of receipt of the request (606) to distribute data and the requesting debug client (602) receives the confirmation (614). In the example of FIG. 6, the confirmation may be implemented as an application-level message having a CONFIRMATION REPLY message type (616).

The method of FIG. 6 continues by sending, by the message router (116) to debug clients identified as intended recipients (602) in the request (606) to distribute data, a reply (622) to the request (606) to distribute data, and receiving, by the debug clients identified as intended recipients (602), the reply (622). In the example of FIG. 6, the reply (622) may be implemented as an application-level message having a REQUEST REPLY message type (624), an identification of a sender of the message (626), an identification (628) of a recipient of each message, an indication (630) of future replies responsive to the request (606) to distribute data, and a payload (632). The payload (632) of the reply (622) includes the data to distribute originally included in the request (606). That is, the payload (632) of the reply (622) is the payload (613) included in the request (606) to distribute data.

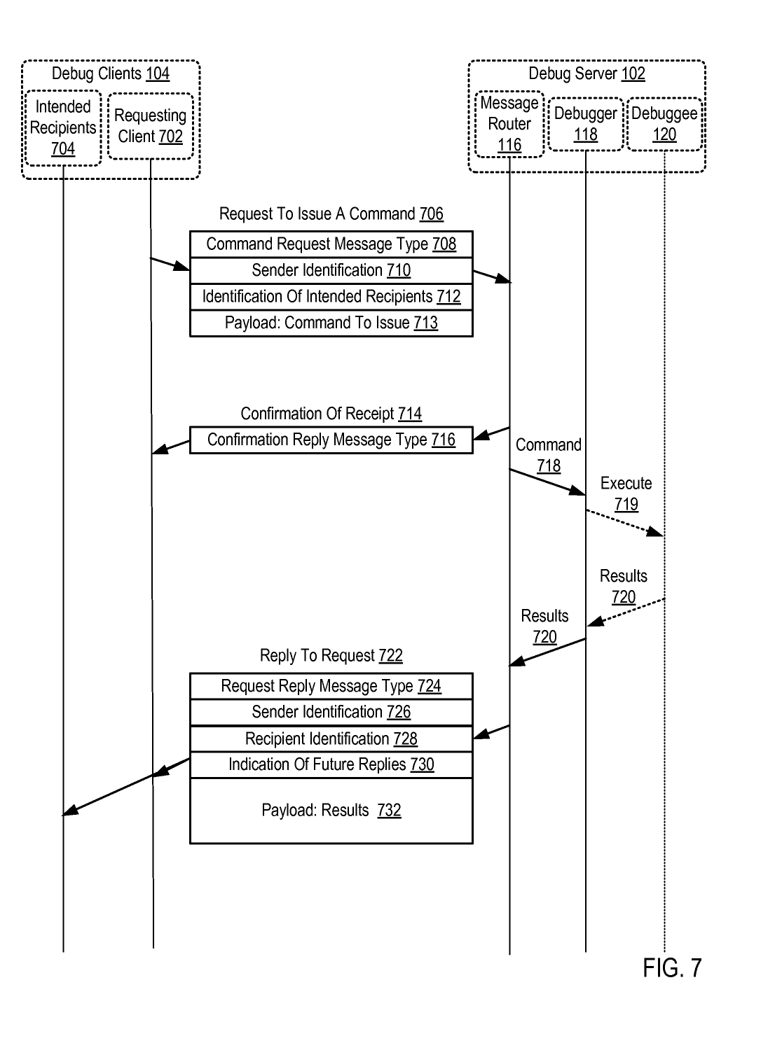

FIG. 7 sets forth a sequence diagram illustrating a further exemplary method of collaborative software debugging in accordance with embodiments of the present invention in which a debug client requests to issue a command to the back-end debugger. The method of FIG. 7 is carried out in a distributed system similar to the system of FIG. 1 which includes a debug server (102), a plurality of debug clients (104), and a data communications network (100 on FIG. 1). The debug server (102) is coupled for data communications to the plurality of debug clients (104) through the data communications network (100). The debug server (102) further includes a debug administrator (114), a message router (116), a back-end debugger (118 on FIG. 1), and a debuggee (120 on FIG. 1).

The method of FIG. 7 includes generating, by a requesting debug client (702), a request (706) to issue a command (718) to the back-end debugger (118), sending the request (706) to the debug server (102), and receiving the request (722) by the message router (116). In the example of FIG. 7, the request (706) may be implemented as an application-level message having a COMMAND REQUEST message type (708), an identification (710) of a sender of the message, an identification (712) of one or more intended recipients of results of executing the command, and a payload (713). The payload (713) of the request (706) in the example of FIG. 7 includes the command to issue to the back-end debugger. The command may be a text command to be entered into a command line interface of the back-end debugger. Examples of commands which may be issued to a back—end debugger through a command line interface, may include: backtrace, step, next, until, continue, clear, help, info breakpoints, info watchpoints, info registers, info threads, and so on as will occur to readers of skill in the art. These are merely some of many possible commands which may be issued to a debugger.

The method of FIG. 7 continues by sending, by the message router (116) to the requesting debug client (702), a confirmation (714) of receipt of the request (706) to issue the command (718) and receiving the confirmation by the requesting debug client (702). In the example of FIG. 7, the confirmation (714) is implemented as an application-level message having a CONFIRMATION REPLY message type (716).

The method of FIG. 7 also includes routing the request (706) to the back-end debugger (118) by issuing the command (718) to the back-end debugger (118) by the message router (116). The method of FIG. 7 continues by the back-end debugger, executing the issued command (718). For some commands, executing the command (718) causes the back-end debugger (118) to initiate execution (719) of the debuggee, for debugging purposes, monitor the execution of the debuggee, and gather results (720) of the execution. For other commands, the command may be executed entirely by the back-end debugger without initiating execution of the debuggee.

After executing the issued command in the example of FIG. 7, the back-end debugger (118) returns to the message router (116) results (720) of the execution of the issued command, the message router receives the results (718). The nature of the results (720) of the execution depend upon the type of command (718) executed by the back-end debugger. A command to evaluate a variable for example, may return as little as an integer, while a command to step into execution of the debuggee may return significantly more information—variable values, register values, memory values, line number, source code file name, and thread number and so on. The results (720), once received by the requesting client (702) may be used to control the client-specific GUI, changing the information displayed on the GUI.

The message router (116) in the example of FIG. 7 sends, to each of the requesting debug client (702) and debug clients (704) identified as intended recipients in the request (706) to issue the command (718), a reply (722) to the request to issue the command and the debug clients (704) and requesting client (702) receive the reply (722). In the example of FIG. 7, the reply (722) may be implemented as an application-level message having a REQUEST REPLY message type (724), an identification (726) of a sender of the message, an identification (728) of a recipient of the message, an indication (730) of future replies responsive to the request (706) to issue the command, and a payload (732) that includes the results (720) of executing the issued command.

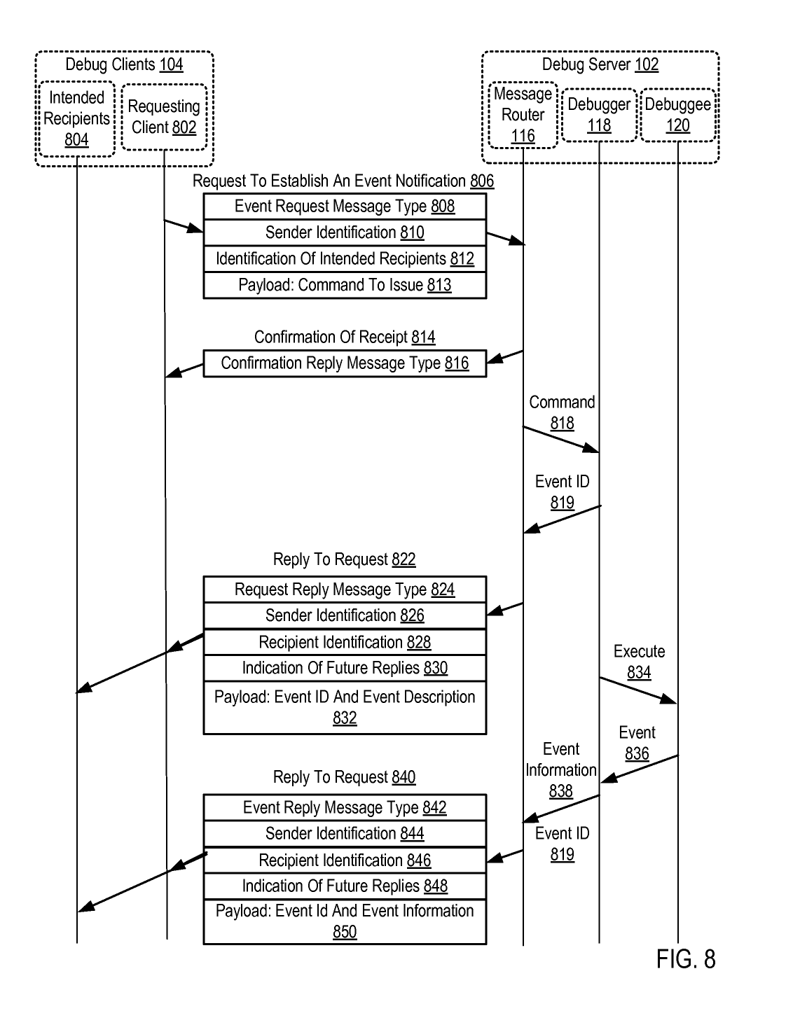

FIG. 8 sets forth a sequence diagram illustrating a further exemplary method of collaborative software debugging in accordance with embodiments of the present invention in which a debug client requests to establish an event notification with the back-end debugger. The method of FIG. 8 is carried out in a distributed system similar to the system of FIG. 1 which includes a debug server (102), a plurality of debug clients (104), and a data communications network (100 on FIG. 1). The debug server (102) is coupled for data communications to the plurality of debug clients (104) through the data communications network (100). The debug server (102) further includes a debug administrator (114), a message router (116), a back-end debugger (118 on FIG. 1), and a debuggee (120 on FIG. 1).

The method of FIG. 8 includes generating, by a requesting debug client (802), a request (806) to establish, with the back-end debugger, an event notification associated with a particular event during the debug session, sending, to the debug server (102), the request (806), and receiving, by the message router, the request (806). In the example of FIG. 8, the request (806) may be implemented as an application-level message having an EVENT REQUEST message type (806), an identification (810) of a sender of the message, an identification (812) of one or more intended recipients of notifications of the of the event, and a payload (813) that includes a command (818) to issue to the back-end debugger (118) to establish the event notification. An event is a predefined occurrence during execution of debuggee. Such an event may include encountering a breakpoint, a watchpoint, a catchpoint, or the like. A breakpoint is a specification of a source code location at which a debuggee will pause or stop execution. A watchpoint is a breakpoint configured to pause or stop execution of the debuggee when a value of a particular expression changes. A catchpoint is another type of breakpoint configured to pause or stop execution of the debuggee when a specified event occurs such as the throwing of an exception or a load of a library, and so on.

The method of FIG. 8 also includes sending, by the message router (116) to the requesting debug client, a confirmation (814) of receipt of the request (806) to establish the event notification and receiving, by the requesting client (802), the confirmation. In the example of FIG. 8, the confirmation may be implemented as an application-level message having a CONFIRMATION REPLY message type (816).

The method of FIG. 8 also includes routing the request (806) to the back-end debugger by issuing, to the back-end debugger, the command (818) to establish the event notification. The back-end debugger (118) in the example of FIG. 8 may then execute the issued command including establishing the event notification associated with the particular event and assigning the event notification an event identifier (819). Establishing a notification of such an event may, for example, include setting and enabling a breakpoint, watchpoint, or catchpoint at a particular location in the source code specified by the requesting debug client (802) in the request (806).

The method of FIG. 8 includes returning, by the back-end debugger (118) to the message router (116), the event identifier (819), sending, by the message router (116) to each of the requesting debug client (802) and debug clients (804) identified as intended recipients in the request (806) to establish the event notification, a reply (822) to the request to establish the event notification, and receiving the reply (822) by the requesting client (802) and the intended recipients (804). In the example of FIG. 8, the reply may be implemented as an application-level message having a REPLY REQUEST message type (824), a sender identification (826), a recipient identification (828), an indication of future replies (830), and a payload (832) that includes the event identifier (832) and optionally a description of the event notification.

The method of FIG. 8 also includes: executing (834) the debuggee (120) by the back-end debugger (118); encountering, during the debug session, the particular event (836) associated with the event notification; providing, by the back-end debugger (118) to the message router (116), information (838) describing the particular event and the event identifier (819); and receiving, by the message router from the back-end debugger, the information (838) describing the particular event and the event identifier (819).

The method of FIG. 8 continues with the message router (116) sending, to each of the requesting debug client (802) and debug clients (804) identified as intended recipients in the request (806) to establish the event notification, a reply (840) to the request to establish the event notification and receiving by the requesting client (802) and by the intended recipients (804), the reply (811). In the example of FIG. 8, the reply (811) to the request (806) to establish the event notification may be implemented as an application-level message having an EVENT REPLY message type (842), a sender identification (844), a recipient identification (846), an indication (848) of future replies responsive to the request establish the event notification, and a payload (850) that includes the information (838) describing the particular event and the event identifier (819).

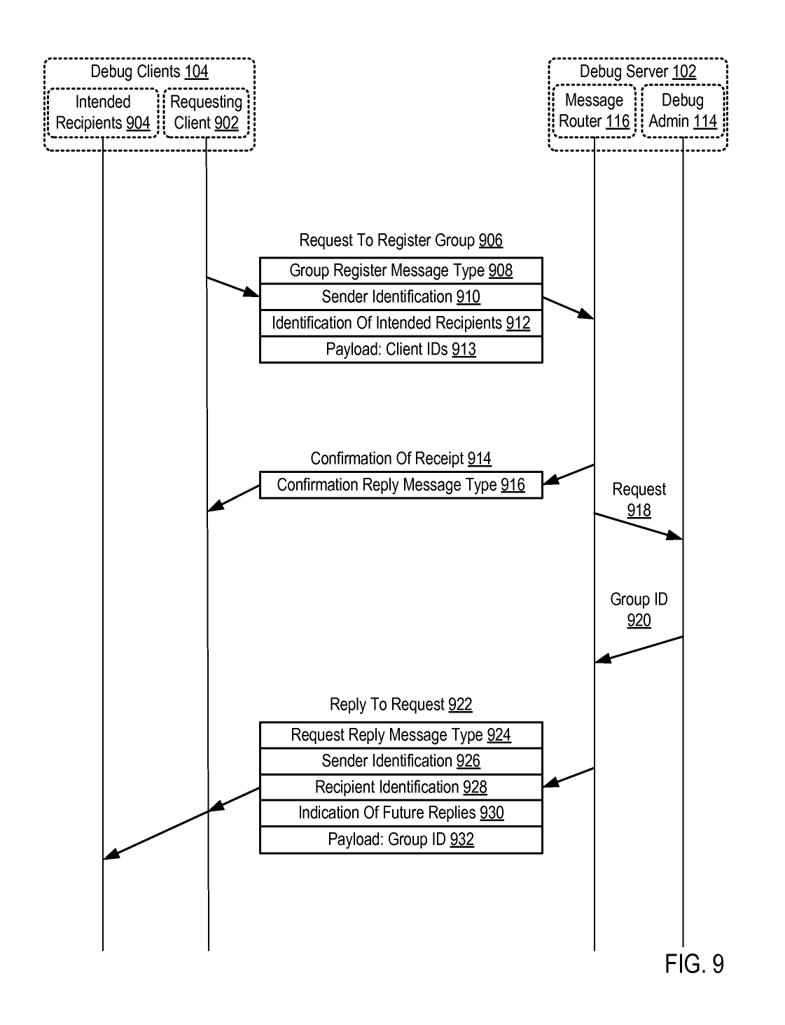

FIG. 9 sets forth a sequence diagram illustrating a further exemplary method of collaborative software debugging in accordance with embodiments of the present invention in which a debug client requests to register a group of debug clients. Once a group of debug clients is registered, as explained below, a group identifier is assigned to the group. Rather than listing out multiple client identifiers application-level messages intended for multiple recipients, debug clients may use a group identifier instead. Group identifiers may also be used for privacy or security in debugging—associating a breakpoint, variable, or portion of source code, for example, with a group identifier of a particular group and providing access only to members of the particular group.

The method of FIG. 9 is carried out in a distributed system similar to the system of FIG. 1 which includes a debug server (102), a plurality of debug clients (104), and a data communications network (100 on FIG. 1). The debug server (102) is coupled for data communications to the plurality of debug clients (104) through the data communications network (100). The debug server (102) further includes a debug administrator (114), a message router (116), a back-end debugger (118 on FIG. 1), and a debuggee (120 on FIG. 1).

The method of FIG. 9 includes generating, by a requesting debug client (902), a request (906) to register a group of debug clients, sending the request (906) to the debug server (102), and receiving the request (906) by the message router (116). In the example of FIG. 9, the request (906) may be implemented as an application-level message having a GROUP REGISTER REQUEST message type (908), a sender identification (910), an identification (912) of one or more intended recipients, and a payload (913) that includes client identifiers of a plurality of debug clients to include in the group of debug clients.

The method of FIG. 9 also includes sending, by the message router (116) to the requesting debug client (902), a confirmation (914) of receipt of the request (906) to register the group and receiving the confirmation (914) by the requesting debug client (902). In the example of FIG. 9, the confirmation (914) may be implemented as an application-level message having a CONFIRMATION REPLY message type (916).

The method of FIG. 9 also includes routing the request (906) to the debug administrator (114) and registering, by the debug administrator (114), the group of debug clients, including assigning the group of debug clients a group identifier (920) unique within the debug session. In the method of FIG. 9, the debug administrator (114) returns the group identifier (920) to the message router (116).

The method of FIG. 9 continues by sending, by the message router (116) to each of the requesting debug client (902) and the debug clients identified as intended recipients (904) in the request (906) to register the group of debug clients, a reply (922) to the request (906) and receiving by the requesting debug client (902) and the intended recipients (904), the reply (922). In the example of FIG. 9, the reply (922) may be implemented as an application-level message having a REQUEST REPLY message type (924), a sender identification (926), a recipient identification (928), an indication (930) of future replies responsive to the request to register the group of debug clients, and a payload (932) that includes the assigned group identifier (920).

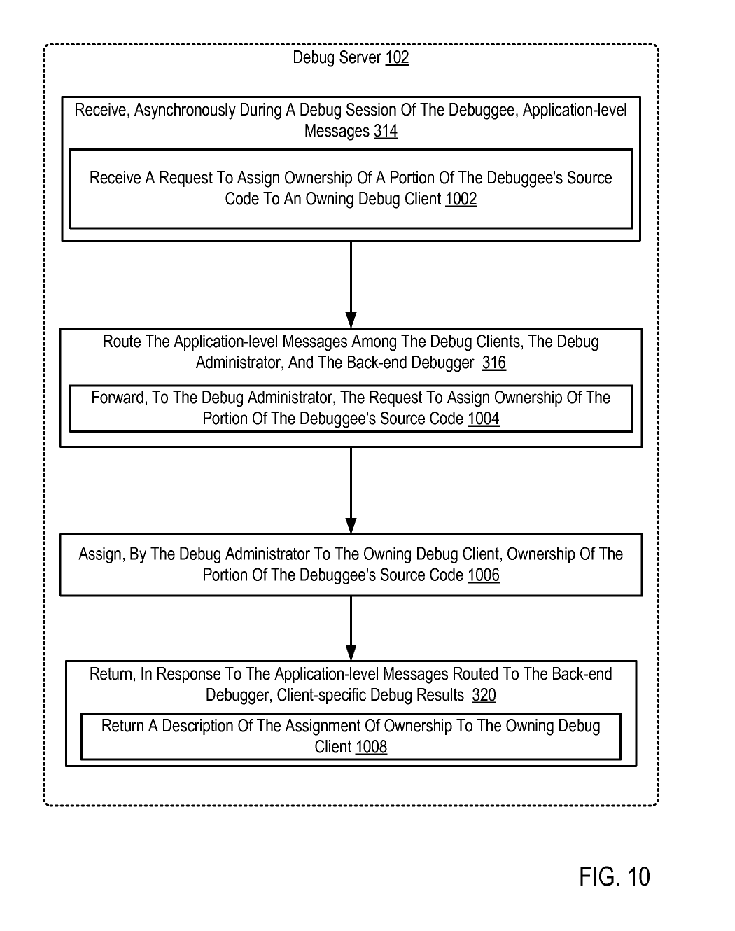

For further explanation, FIG. 10 sets forth a flowchart illustrating a further exemplary method of collaborative software debugging in a distributed system, such as the example system depicted in FIG. 1, in accordance with embodiments of the present invention. FIG. 10 is directed primarily to operation of the debug server, rather than the debug clients, in carrying out collaborative debugging in accordance with embodiments of the present invention. FIG. 10 is similar to the method of FIG. 3 in that the method of FIG. 10 includes receiving (314) a plurality of application-level messages, routing (316) the application-level messages, and returning (320) client-specific debug results.

The method of FIG. 10 differs from the method of FIG. 3, however, in that in the method of FIG. 10, receiving (314) a plurality of application-level messages includes receiving (1002) a request to assign ownership of a portion of the debuggee's source code to an owning debug client. Receiving (1002) a request to assign ownership may be carried out by receiving one or more application-level messages having a DISTRIBUTE DATA message type as described in FIG. 6, having a COMMAND REQUEST message type as described in FIG. 7, or in other ways as will occur to readers of skill in the art.

In the method of FIG. 10, routing (316) the application-level messages is carried out by forwarding (1004), to the debug administrator, the request to assign ownership of the portion of the debuggee's source code. Forwarding (1004) the request to the debug administrator may be carried out by sending the request via inter-process communications methods.

The method of FIG. 10 also includes assigning (1006), by the debug administrator to the owning debug client, ownership of the portion of the debuggee's source code. Assigning (1006) ownership to the owning debug client may be carried in various ways including for example, by maintaining a data structure comprising records, each of which represents an ownership assignment and includes an association of a client identifier, a beginning source code line, and an ending source code line.

In the method of FIG. 10, returning (320) client-specific debug results includes returning (1008) to the debug clients a description of the assignment of ownership to the owning debug client. Returning (1008) to the debug clients a description of the assignment of ownership to the owning debug client including by sending a reply to debug clients listed as intended recipients in the originally received request to assign ownership—whether the request is received in the form of a DISTRIBUTE DATA message or COMMAND REQUEST message.

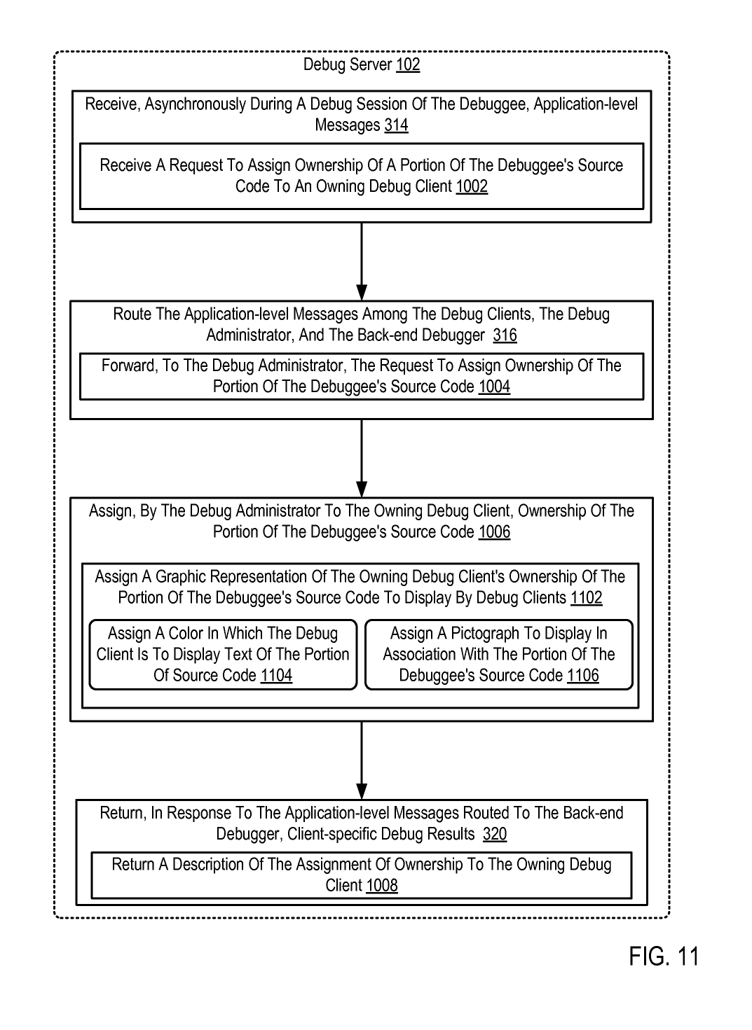

For further explanation, FIG. 11 sets forth a flowchart illustrating a further exemplary method of collaborative software debugging in a distributed system, such as the example system depicted in FIG. 1, in accordance with embodiments of the present invention. FIG. 11 is similar to the method of FIG. 10 in that the method of FIG. 11 is carried out by a debug server and includes receiving (1002) a request to assign ownership, forwarding (1004) the request, assigning (1102) ownership of the portion, and returning (1008) to the debug clients a description of the assignment of ownership to the owning debug client.

The method of FIG. 11 differs from the method of FIG. 10, however, in that in the method of FIG. 11, assigning (1006), by the debug administrator to the owning debug client, ownership of the portion of the debuggee's source code includes assigning (1102) a graphic representation of the owning debug client's ownership of the portion of the debuggee's source code to display by debug clients. In the method of FIG. 11, assigning (1102) a graphic representation includes either or both of assigning (1104) a color in which the debug client is to display text of the portion of source code and assigning (1106) a pictograph to display in association with the portion of the debuggee's source code.

In the method of FIG. 11, the debug server (102)—via the debug administrator—assigns graphic representations of ownership. In other embodiments, similar to embodiments described below, each debug client may individually administer such graphic representations of ownership. For example, a first debug client, DC_1 may display source code owned by DC_2 in blue text, while DC_3 displays source code owned by DC_2 in green text. That is, in some cases, the debug administrator and debug server provides debug clients only with ownership information not display information.

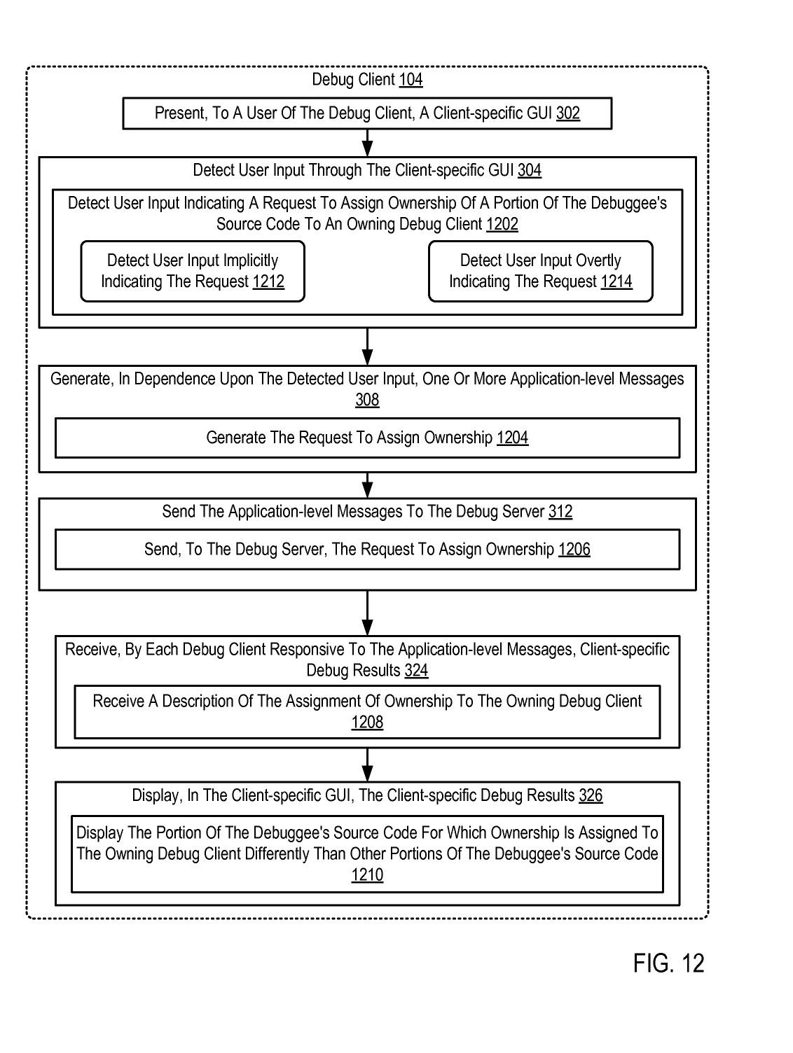

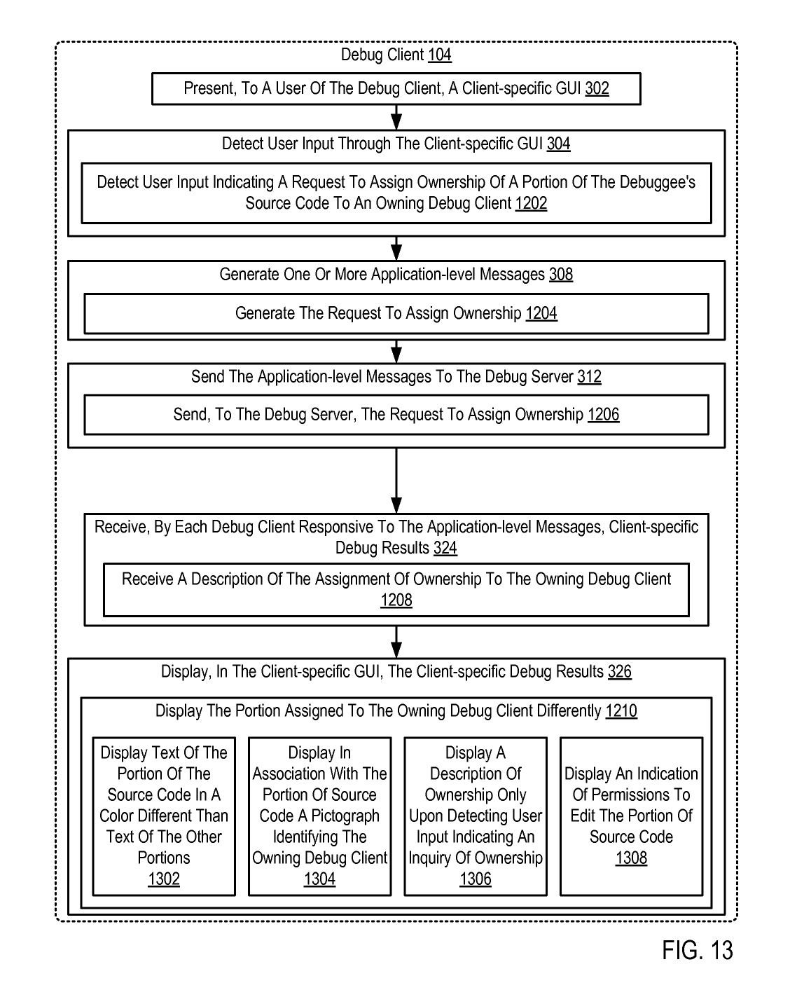

As mentioned above, FIGS. 10 and 11 are directed primarily at operation of the debug server (102). By contrast, FIGS. 12 and 13 present a method carried out primarily by the debug clients (104). For further explanation, therefore, FIG. 12 sets forth a flowchart illustrating a further exemplary method of collaborative software debugging in a distributed system in accordance with embodiments of the present invention. The method of FIG. 12 is similar to the method of FIG. 3 including, as it does, presenting (302) a client-specific GUI, detecting (304) user input, generating (308) one or more application-level messages, sending (312) the application-level messages to the debug server, receiving (324) client-specific debug results, and displaying (326) the client-specific debug results in the client-specific GUI.

The method of FIG. 12 differs from the method of FIG. 3, however, in that in the method of FIG. 12, detecting (304) user input is carried out by detecting (1202) user input indicating a request to assign ownership of a portion of the debuggee's source code to an owning debug client. In the example of FIG. 12, detecting (1102) user input indicating a request to assign ownership includes either or both of detecting (1212) user input implicitly indicating the request and detecting (1214) user input overtly indicating the request. An implicit indication of a request to assign ownership may be implemented in various ways, including for example, as a user editing text of the portion of source code in a client-specific GUI. That is, in some embodiments the debug client most recently editing a portion of source code is the considered the ‘owner’ of that portion. Another type implicit indication of ownership includes generating the text. That is, the creator of a portion of source code, in some embodiments, is considered an ‘owner’ of that portion. By contrast, an overt indication of a request to assign ownership may include a user's selection, via a GUI, of a portion of source code followed by the user's selection of a GUI item designated for assigning ownership. Consider, as an example of overt request, the example GUI (124) of FIG. 2 in which a user selects a GUI menu item designated for setting ownership of a portion of source code.

In the method of FIG. 12, generating (308) application-level messages includes generating (308) the request to assign ownership. Generating (308) the request to assign ownership may be carried out by generating one or more DISTRIBUTE DATA application-level messages, COMMAND REQUEST application-level messages, or other message types.

In the method of FIG. 12, sending (312) the application-level messages to the debug server includes sending (1206), to the debug server, the request to assign ownership and receiving (324) client-specific debug results includes receiving (1208) a description of the assignment of ownership to the owning debug client. A description of the assignment may include a client identifier, a starting line in source code, and an ending line in source code. In some embodiments the description also includes an assignment of graphic representation of ownership—a pictograph or source code text color. Receiving (1208) such a description may be carried out by receiving a REQUEST REPLY application-level message as a reply to the original request to assign ownership.

In the method of FIG. 12, displaying (326) the client-specific debug results includes displaying (1210) the portion of the debuggee's source code for which ownership is assigned to the owning debug client differently than other portions of the debuggee's source code for which ownership is not assigned to the owning debug client. As explained above, each debug client may separately administer graphic representations of ownership for portion of source code, or alternatively, the debug server may administer such representations of ownership. In the first embodiments, each debug client may graphically reproduce ownership information differently for the same portion of source code. In the second embodiment, each debug client graphically reproduces ownership information in the same manner for the same portion of source code.

For further explanation, FIG. 13 sets forth a flowchart illustrating a further exemplary method of collaborative software debugging in a distributed system in accordance with embodiments of the present invention. The method of FIG. 13 is similar to the method of FIG. 12 including, as it does, detecting (1202) user input indicating a request to assign ownership; generating (1204) the request to assign ownership; sending (1206), to the debug server, the request to assign ownership; receiving (1208) a description of the assignment of ownership to the owning debug client; and displaying (1208) the portion of the debuggee's source code for which ownership is assigned to the owning debug client differently than other portions of the debuggee's source code for which ownership is not assigned to the owning debug client.

The method of FIG. 13 differs from the method of FIG. 12, however, in that in the method of FIG. 13, displaying (1210) the portion of the debuggee's source code for which ownership is assigned to the owning debug client differently than other portions of the debuggee's source code for which ownership is not assigned to the owning debug client includes displaying (1302) text of the portion of the debuggee's source code for which ownership is assigned to the owning debug client in a color different than text of the other portions; displaying (1304) in association with the portion of the debuggee's source code for which ownership is assigned to the owning debug client a pictograph identifying the owning debug client; displaying (1306) a description of ownership only upon detecting user input indicating an inquiry of ownership of the portion of the debuggee's source code for which ownership is assigned to the owning debug client; and displaying (1308) an indication of permissions to edit the portion of source code for which ownership is assigned to the owning debug client.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart, block diagrams, and sequence diagrams, in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of collaborative software debugging in a distributed system, the distributed system comprising a debug server, a plurality of debug clients, and a data communications network, the debug server coupled for data communications to the plurality of debug clients through the data communications network, the debug server comprising a debug administrator, a message router, a back-end debugger, and a debuggee, the method comprising:
receiving, by the debug server from the debug clients asynchronously during a debug session of the debuggee, a plurality of application-level messages including receiving a request to assign ownership of a portion of the debuggee's source code to an owning debug client;
routing, by the message router in accordance with an application-level message passing protocol, the application-level messages among the debug clients, the debug administrator, and the back-end debugger, including providing distributed control of the back-end debugger to the debug clients with application-level messages routed to the back-end debugger and forwarding, to the debug administrator, the request to assign ownership of the portion of the debuggee's source code;
assigning, by the debug administrator to the owning debug client, ownership of the portion of the debuggee's source code; and
returning, by the debug server to the debug clients in response to the application-level messages routed to the back-end debugger, client-specific debug results, including returning to the debug clients a description of the assignment of ownership to the owning debug client.

2. The method of claim 1, wherein assigning ownership of the portion of the debuggee's source code further comprises assigning a graphic representation of the owning debug client's ownership of the portion of the debuggee's source code to display by debug clients.

3. The method of claim 2, wherein assigning the graphic representation further comprises assigning a color in which the debug client is to display text of the portion of source code.

4. The method of claim 2, wherein assigning the graphic representation further comprises assigning a pictograph to display in association with the portion of the debuggee's source code, the pictograph identifying the owning debug client.

5. A method of collaborative software debugging in a distributed system, the distributed system comprising a debug server, a plurality of debug clients, and a data communications network, the debug server coupled for data communications to the plurality of debug clients through the data communications network, the debug server comprising a debug administrator, a message router, a back-end debugger, and a debuggee, the method comprising:
presenting, by each debug client to a user of the debug client, a client-specific graphical user interface (‘GUI’), the client-specific GUI comprising a client-specific display of a debug session of the debuggee;
detecting, by each debug client, user input through the client-specific GUI, including detecting user input indicating a request to assign ownership of a portion of the debuggee's source code to an owning debug client;
generating, by each debug client in dependence upon the detected user input, one or more application-level messages, including generating the request to assign ownership;
sending, by each debug client, the application-level messages to the debug server, including sending, to the debug server, the request to assign ownership;
receiving, by each debug client responsive to the application-level messages, client-specific debug results, including receiving a description of the assignment of ownership to the owning debug client; and
displaying, by each debug client in the client-specific GUI, the client-specific debug results, including displaying the portion of the debuggee's source code for which ownership is assigned to the owning debug client differently than other portions of the debuggee's source code for which ownership is not assigned to the owning debug client.

6. The method of claim 5, wherein detecting user input indicating a request to assign ownership of a portion of the debuggee's source code to an owning debug client further comprises detecting user input implicitly indicating the request.

7. The method of claim 5, wherein detecting user input indicating a request to assign ownership of a portion of the debuggee's source code to an owning debug client further comprises detecting user input overtly indicating the request.

8. The method of claim 5, wherein displaying the portion of the debuggee's source code for which ownership is assigned to the owning debug client differently than other portions of the debuggee's source code for which ownership is not assigned to the owning debug client further comprises displaying text of the portion of the debuggee's source code for which ownership is assigned to the owning debug client in a color different than text of the other portions.

9. The method of claim 5, wherein displaying the portion of the debuggee's source code for which ownership is assigned to the owning debug client differently than other portions of the debuggee's source code for which ownership is not assigned to the owning debug client further comprises displaying in association with the portion of the debuggee's source code for which ownership is assigned to the owning debug client a pictograph identifying the owning debug client.

10. The method of claim 5, wherein displaying the portion of the debuggee's source code for which ownership is assigned to the owning debug client differently than other portions of the debuggee's source code for which ownership is not assigned to the owning debug client further comprises displaying a description of ownership only upon detecting user input indicating an inquiry of ownership of the portion of the debuggee's source code for which ownership is assigned to the owning debug client.

11. The method of claim 5, wherein displaying the portion of the debuggee's source code for which ownership is assigned to the owning debug client differently than other portions of the debuggee's source code for which ownership is not assigned to the owning debug client further comprises displaying an indication of permissions to edit the portion of source code for which ownership is assigned to the owning debug client.

12. An apparatus for collaborative software debugging in a distributed system, the distributed system comprising a debug server, a plurality of debug clients, and a data communications network, the debug server coupled for data communications to the plurality of debug clients through the data communications network, the debug server comprising a debug administrator, a message router, a back-end debugger, and a debuggee, the apparatus comprising a computer processor, a computer memory operatively coupled to the computer processor, the computer memory having disposed within it computer program instructions that, when executed by the computer processor, cause the apparatus to carry out the steps of:
presenting, by each debug client to a user of the debug client, a client-specific graphical user interface (‘GUI’), the client-specific GUI comprising a client-specific display of a debug session of the debuggee;
detecting, by each debug client, user input through the client-specific GUI, including detecting user input indicating a request to assign ownership of a portion of the debuggee's source code to an owning debug client;
generating, by each debug client in dependence upon the detected user input, one or more application-level messages, including generating the request to assign ownership;
sending, by each debug client, the application-level messages to the debug server, including sending, to the debug server, the request to assign ownership;
receiving, by each debug client responsive to the application-level messages, client-specific debug results, including receiving a description of the assignment of ownership to the owning debug client; and
displaying, by each debug client in the client-specific GUI, the client-specific debug results, including displaying the portion of the debuggee's source code for which ownership is assigned to the owning debug client differently than other portions of the debuggee's source code for which ownership is not assigned to the owning debug client.

13. The apparatus of claim 12, wherein detecting user input indicating a request to assign ownership of a portion of the debuggee's source code to an owning debug client, further comprises detecting user input implicitly indicating the request.

14. The apparatus of claim 12, wherein detecting user input indicating a request to assign ownership of a portion of the debuggee's source code to an owning debug client, further comprises detecting user input overtly indicating the request.

15. The apparatus of claim 12, wherein displaying the portion of the debuggee's source code for which ownership is assigned to the owning debug client differently than other portions of the debuggee's source code for which ownership is not assigned to the owning debug client further comprises displaying text of the portion of the debuggee's source code for which ownership is assigned to the owning debug client in a color different than text of the other portions.

16. The apparatus of claim 12, wherein displaying the portion of the debuggee's source code for which ownership is assigned to the owning debug client differently than other portions of the debuggee's source code for which ownership is not assigned to the owning debug client further comprises displaying in association with the portion of the debuggee's source code for which ownership is assigned to the owning debug client a pictograph identifying the owning debug client.

17. The apparatus of claim 12, wherein displaying the portion of the debuggee's source code for which ownership is assigned to the owning debug client differently than other portions of the debuggee's source code for which ownership is not assigned to the owning debug client further comprises displaying a description of ownership only upon detecting user input indicating an inquiry of ownership of the portion of the debuggee's source code for which ownership is assigned to the owning debug client.

18. The apparatus of claim 12, wherein displaying the portion of the debuggee's source code for which ownership is assigned to the owning debug client differently than other portions of the debuggee's source code for which ownership is not assigned to the owning debug client further comprises displaying an indication of permissions to edit the portion of source code for which ownership is assigned to the owning debug client.

19. A computer program product for collaborative software debugging in a distributed system, the distributed system comprising a debug server, a plurality of debug clients, and a data communications network, the debug server coupled for data communications to the plurality of debug clients through the data communications network, the debug server comprising a debug administrator, a message router, a back-end debugger, and a debuggee, the computer program product disposed upon a computer readable storage medium, the computer program product comprising computer program instructions that, when executed by a computer processor of a computer, cause the computer to carry out the steps of:
presenting, by each debug client to a user of the debug client, a client-specific graphical user interface (‘GUI’), the client-specific GUI comprising a client-specific display of a debug session of the debuggee;
detecting, by each debug client, user input through the client-specific GUI, including detecting user input indicating a request to assign ownership of a portion of the debuggee's source code to an owning debug client;
generating, by each debug client in dependence upon the detected user input, one or more application-level messages, including generating the request to assign ownership;
sending, by each debug client, the application-level messages to the debug server, including sending, to the debug server, the request to assign ownership;
receiving, by each debug client responsive to the application-level messages, client-specific debug results, including receiving a description of the assignment of ownership to the owning debug client; and
displaying, by each debug client in the client-specific GUI, the client-specific debug results, including displaying the portion of the debuggee's source code for which ownership is assigned to the owning debug client differently than other portions of the debuggee's source code for which ownership is not assigned to the owning debug client.

20. The computer program product of claim 19, wherein detecting user input indicating a request to assign ownership of a portion of the debuggee's source code to an owning debug client, further comprises detecting user input implicitly indicating the request.

21. The computer program product of claim 19, wherein detecting user input indicating a request to assign ownership of a portion of the debuggee's source code to an owning debug client, further comprises detecting user input overtly indicating the request.

22. The computer program product of claim 19, wherein displaying the portion of the debuggee's source code for which ownership is assigned to the owning debug client differently than other portions of the debuggee's source code for which ownership is not assigned to the owning debug client further comprises displaying text of the portion of the debuggee's source code for which ownership is assigned to the owning debug client in a color different than text of the other portions.

23. The computer program product of claim 19, wherein displaying the portion of the debuggee's source code for which ownership is assigned to the owning debug client differently than other portions of the debuggee's source code for which ownership is not assigned to the owning debug client further comprises displaying in association with the portion of the debuggee's source code for which ownership is assigned to the owning debug client a pictograph identifying the owning debug client.

24. The computer program product of claim 19, wherein displaying the portion of the debuggee's source code for which ownership is assigned to the owning debug client differently than other portions of the debuggee's source code for which ownership is not assigned to the owning debug client further comprises displaying a description of ownership only upon detecting user input indicating an inquiry of ownership of the portion of the debuggee's source code for which ownership is assigned to the owning debug client.
